(19) United States
(12) Patent Application Publication
(10) Pub. No.: US 2009/0097258 A1
(43) Pub. Date: Apr. 16, 2009

(54) LED FIXTURE CAPABLE OF PERFORMING LIGHT-BEAM ADJUSTMENT

(76) Inventors: Jui-Huang TSENG, Jhonghe City (TW); Chia-Li CHEN, Jhonghe City (TW)

Correspondence Address: HDLS Patent & Trademark Services, P.O. BOX 220746, CHANTILLY, VA, 20153-0746, US

(21) Appl. No.: 12/244,124

(22) Filed: Oct. 2, 2008

(30) Foreign Application Priority Data
Oct. 12, 2007 (TW) 096217111

(51) Int. Cl. F21V 7/04

(52) U.S. Cl. 362/296.05

(57) ABSTRACT

An LED fixture capable of performing light-beam adjustment includes a lamp holder and a lamp cover. One side of the lamp holder is arranged an illuminating module having an LED lamp that is arranged on the illuminating module with an angle. The lamp cover is connected to the lamp holder, while the illuminating module is accommodated in the lamp cover. A reflecting face with a specific curvature is arranged on an inner face of the lamp cover in a way, such that the illuminating direction of the LED lamp is toward the reflecting face, making a light irradiated from the LED light source able to be reflected outwardly by the reflecting face. Since the lamp holder and the lamp cover are movably combined through a mobile manner, when the lamp holder or the lamp cover is rotated, the relative position between the LED light source and the reflecting face is changed, thus that a variation of illuminating ranges is formed.

### BACKGROUND OF THE INVENTION

1. Field of the Invention

The present invention in general relates to an LED fixture capable of performing light-beam adjustment, in particular, to an LED fixture that can provide illuminating ranges of different light-beam angles by a structural design of rotary lamp holder or lamp cover, whereby the LED fixture is adoptable by the users of flashlight, projecting lamp, head lamp, etc.

2. Description of Prior Art

Following a daily change of technology, illuminating light source is gradually replaced by LED (Light-Emitting Diode). Since LED has many merits such as high brightness, power saving, small size and environmental friendliness, many illuminating products, from personal products of small size (e.g., flashlight), working illumination (e.g., head lamp) to traffic facilities and projecting lamp of large size, all adopt LED designed as light source.

Currently, the illumination objective of usage and R&D of LED aims to the promotion of brightness and the enhancement of efficiency. However, the relative design was frequently focused on the illumination of a single range and angle provided by an LED fixture. For example, a flashlight most time adopts a traditional bulb and the design of a fixed focal distance (length). If the light beam's focal distance needs change, the design methodology most time adopts a linear moving manner to change the relative position between the reflecting cup and the traditional bulb. However, since LED is a plane light source illuminating light beam with 180 degrees, which is different from the traditional bulb with a spherical illumination of 360 degrees, LED can not adopt the aforementioned linear moving manner to make an adjustment of light beam. Although illuminating devices that use the methodology of changing the relative position between the reflecting cup and the LED are available in the market, their adjusting effect to the light beam is still unsatisfactory.

Accordingly, aiming to solve aforementioned shortcomings, after a substantially devoted study, in cooperation with the application of relatively academic principles, the inventor has finally proposed the present invention that is designed reasonably to possess the capability to improve the prior arts significantly.

### SUMMARY OF THE INVENTION

The invention is mainly to provide an LED fixture capable of performing providing illuminating ranges of different light beam angles through a structural design of rotary lamp holder or lamp cover.

The invention is to provide an LED fixture capable of performing light beam adjustment, including a lamp holder and a lamp cover. One side of the lamp holder is arranged an illuminating module having LED lamp. The LED lamp is arranged at the illuminating module with an angle relative to the horizontally forward line. The lamp cover is movably combined to the lamp holder and can be moved through a left-and-right rotary manner, while the illuminating module is accommodated in the lamp cover. A reflecting face having a specific curvature is arranged on an inner face of the lamp cover and the illuminating direction of the LED lamp is toward the reflecting face, making the light irradiated from the LED light source able to be reflected outwardly by the reflecting face. When rotating the lamp cover, the relative position between the LED light source and the reflecting face is also changed, thus that a variation of illuminating ranges is formed.

Again, one side of the lamp holder of the aforementioned LED fixture is arranged an illuminating module having LED lamp. The LED lamp is arranged at the illuminating module with an angle relative to the horizontally forward line. The lamp cover is movably combined to the lamp holder in a way, such that the combined lamp holder can rotate with respect to the lamp cover, making the LED lamp of the illuminating module rotated in the lamp cover. Meanwhile, a reflecting face having a specific curvature is arranged on an inner face of the lamp cover, making the light irradiated from the LED light source able to be reflected outwardly by the reflecting face. When rotating the LED lamp, the relative position between the LED light source and the reflecting face is changed, thus that a variation of illuminating ranges is formed.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective illustration of the outer appearance of an LED fixture according to a preferable embodiment of the present invention;

FIG. 2 is a perspective illustration of the outer appearance of an LED fixture according to a preferable embodiment of the present invention, when the lamp cover is rotated an angle;

FIG. 3 is a cross-sectional view of a using status of an LED fixture according to a preferable embodiment of the present invention, when the lamp cover is rotated an angle and after the light irradiated from the light source is reflected by the reflecting face;

FIG. 4 is a cross-sectional view of a using status of an LED fixture according to a preferable embodiment of the present invention, when the lamp cover is rotated another angle and after the light irradiated from the light source is reflected by the reflecting face;

FIG. 5 is a perspective illustration of the outer appearance of an LED fixture according to a preferable embodiment of the present invention, when the LED fixture is applied to a flashlight;

FIG. 6 is a perspective illustration of the outer appearance of an LED fixture according to a preferable embodiment of the present invention, when the LED fixture is applied to a head lamp; and

FIG. 7 is a perspective illustration of the outer appearance of an LED fixture according to another preferable embodiment of the present invention.

### DETAILED DESCRIPTION OF THE INVENTION

In cooperation with attached drawings, the technical contents and detailed description of the present invention are described thereinafter according to a number of preferable embodiments, being not used to limit its executing scope. Any equivalent variation and modification made according to appended claims is all covered by the claims claimed by the present invention.

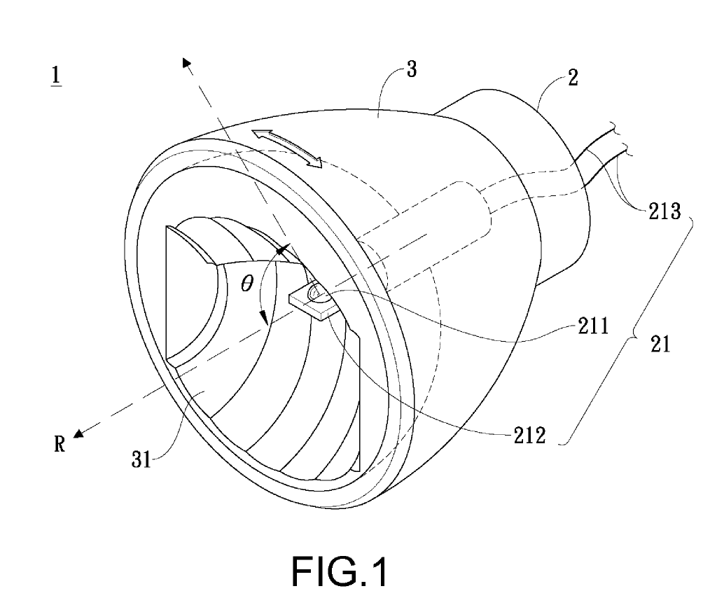

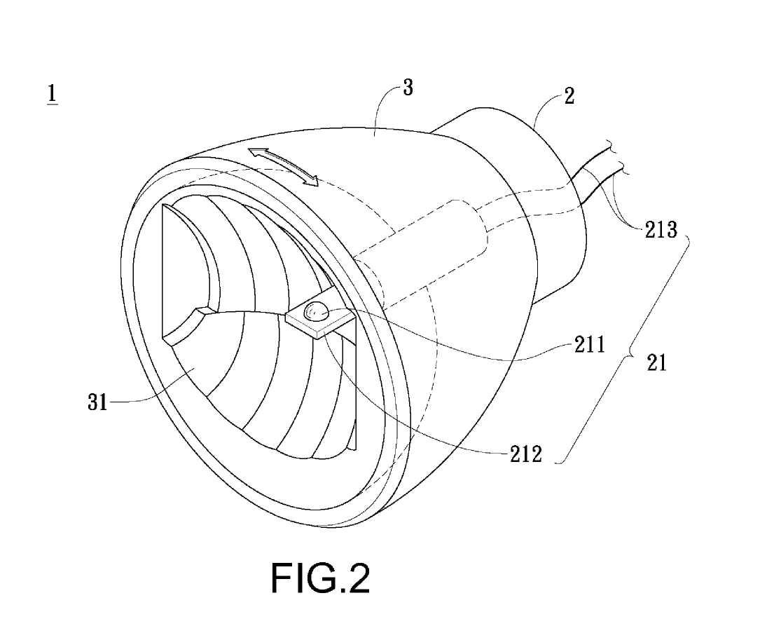

Please refer to FIG. 1 through FIG. 4, which show an LED fixture capable of performing light-beam adjustment according to a preferable embodiment of the present invention, mainly including a lamp holder 2 and a lamp cover 3.

One side of the lamp holder 2 is arranged an illuminating module 21 having LED lamp 211. The LED lamp 211 is installed at the illuminating module 21 with an angle Θ (for example, 75-105 degrees) relative to a horizontally forward direction R, making the LED lamp 211 shown an illumination in upward or downward direction. Additionally, the illuminating module 21 further includes a cooler 212 connected to the LED lamp 211 and a circuit device 213 providing a power source needed by the LED lamp 211.

The lamp cover 3 is movably combined to the lamp holder 2 through a left-and-right rotary manner, while the illuminating module 21 is accommodated in the lamp cover 3. Inside, a reflecting face 31 having a specific curvature is arranged on an inner face of the lamp cover 3 and the illuminating direction of the LED lamp 211 is toward the reflecting face 31. Since of the requirement of use, the reflecting face 31 can be designed in advance as a rough face having uneven stripes or as a smooth face having a specific curvature, making a light irradiated from the LED lamp 211 reflected by the reflecting face 31. When rotating the lamp cover 3, the relative position between the light source of LED lamp 211 and the reflecting face 31 is changed, thus that a variation of illuminating range is formed.

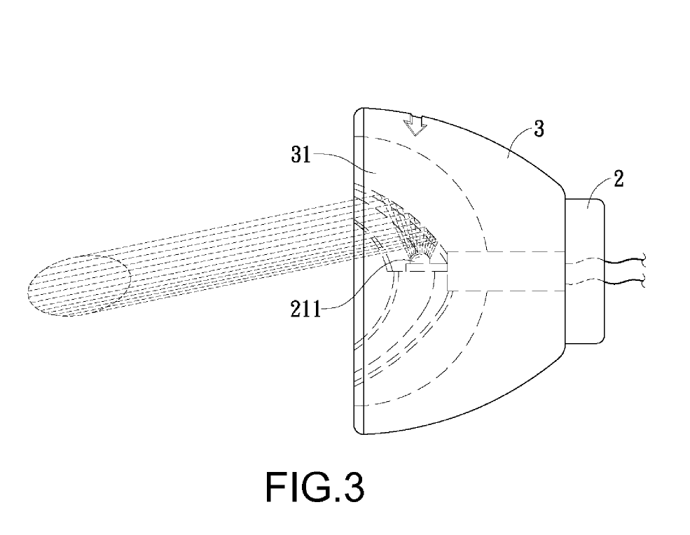

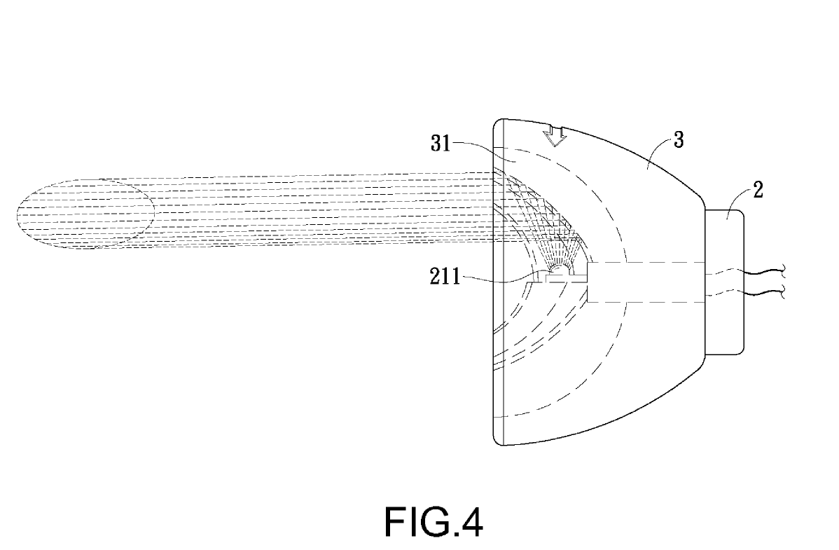

During implementation, according to the requirement of user, in the course of manufacture, the invention can design a specific curvature needed by the reflecting face 31, thus that an intended intensity effect of the light-beam angle can be fulfilled in advance. Therefore, please refer to FIG. 3 and FIG. 4, again. When irradiated from an LED lamp 211 arranged at one side of the lamp holder 2 and projecting onto the reflecting face 31 of the lamp cover 31, the light is reflected outwardly by the reflecting face 31. When the user is intended to change the illuminating range, he just needs to rotate the lamp cover 3. Since the lamp cover 3 has been rotated, the position of the reflecting face 31 arranged on an inner face of the lamp cover 3 is also changed. Thereby, the relative position between the light source of LED lamp 211 and the reflecting face 31 is changed as well, thus that a variation of illuminating range is formed.

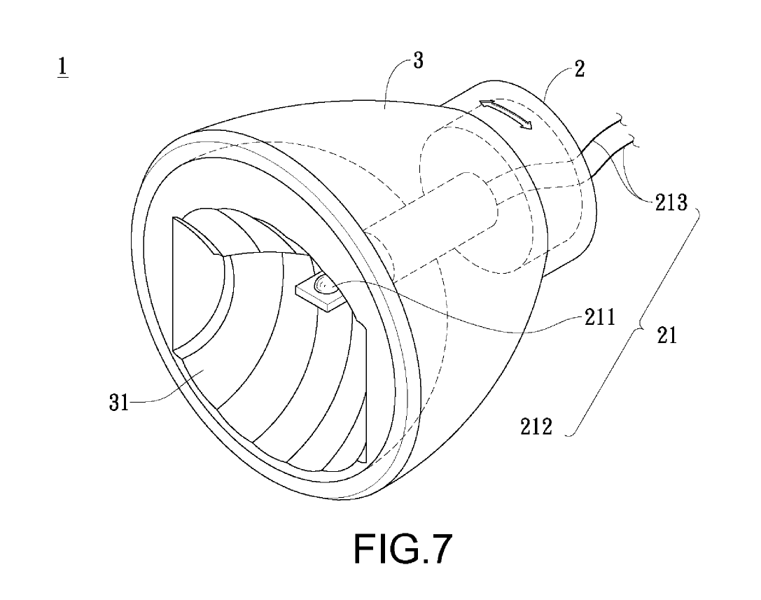

Furthermore, please refer to FIG. 7, which shows an embodiment different from the aforementioned embodiment in that the latter can provide illuminating ranges of different light-beam angles, through rotation of the lamp cover. In this preferable embodiment, after the lamp cover 3 and the lamp holder 2 are movably combined, the lamp holder 2 can be rotated with respect to the lamp cover 3, making the LED lamp 211 of the illuminating module 21 rotated in the lamp cover 3. When the light irradiated from the LED lamp 211 projects onto the reflecting face 31 and is reflected outwardly by the reflecting face 31, through the rotation of the LED lamp 211, the relative position between the light source of LED lamp 211 and the reflecting face 31 is changed, thus that a variation of illuminating range is formed.

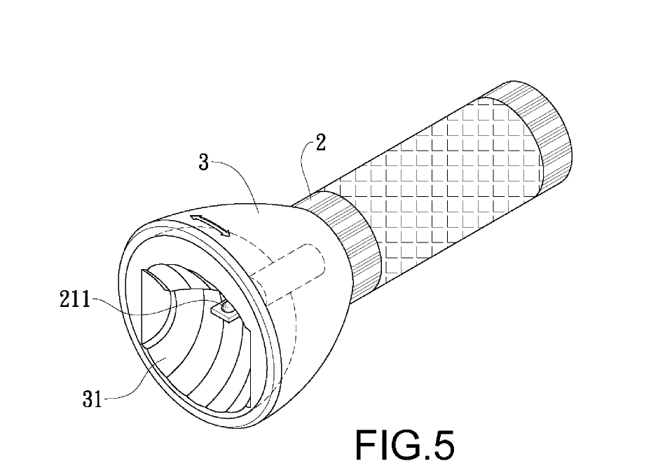

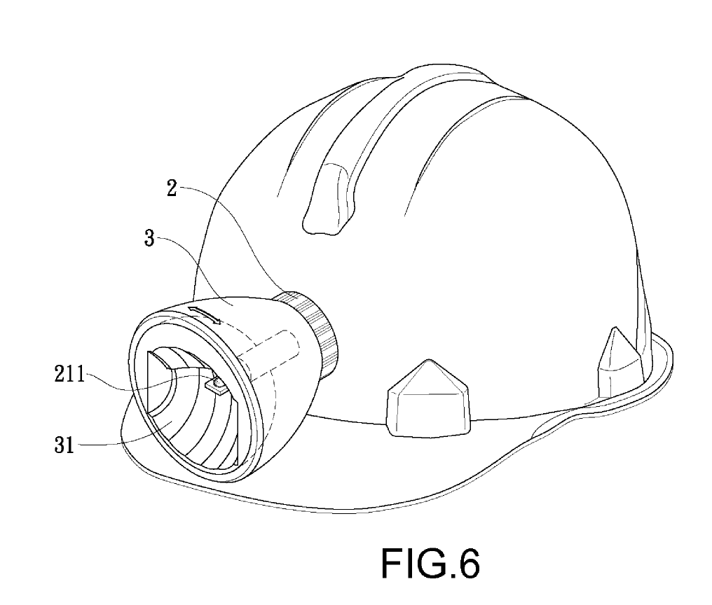

Thereby, on the one hand, the invention can be designed by making the light source of LED lamp 211 project directly onto a reflecting face 31 arranged on an inner face of the lamp cover 3 that can be rotated with respect to the lamp holder 2, when the lamp cover 3 is rotated, it being possible to provide illuminating ranges of different light-beam angles to an LED fixture 1 to thereby possess a function of light-beam adjustment, which can be adopted by flashlight and head lamp, as shown in FIG. 5 and FIG. 6, making a user just only use a rotating manner to the lamp cover 3 to thereby change the illuminating range. On the other hand, the invention can be designed by making the lamp holder 2 rotated with respect to the lamp cover 3, making the LED lamp 211 of the illuminating module 21 rotated in the lamp cover 3, after the projecting light is reflected outwardly by the reflecting face 31, through rotating the LED lamp 211, a variation of illuminating ranged being thus formed, as shown in FIG. 7, so the invention has the merits of simpler structure, easier use and lower cost.

According to the aforementioned structure, an LED fixture capable of performing light-beam adjustment of the present invention is thereby obtained.

Summarizing aforementioned description, the invention is an indispensable product of novelty indeed, which may positively reach the expected usage objective for solving the drawbacks of the prior arts, and which extremely possesses the innovation and progressiveness for completely fulfilling the applying merits of new type patent, according to which the invention is thereby applied. Please examine the application carefully and grant it as a formal patent for protecting the rights of the inventor.

However, the aforementioned description is only a number of preferable embodiments according to the present invention, being not used to limit the patent scope of the invention, so equivalently structural variation made to the contents of the present invention, for example, description and drawings, is all covered by the claims claimed thereinafter.

What is claimed is:

1. An LED fixture capable of performing light-beam adjustment, including
a lamp holder, one side of which is arranged an illuminating module having an LED lamp, the LED lamp being arranged at the illuminating module with an angle relative to a horizontally forward line; and
a lamp cover, which is movably combined to the lamp holder and can be moved through a left-and-right rotary manner, while the illuminating module is accommodated in the lamp cover;
wherein a reflecting face with a specific curvature is arranged on an inner face of the lamp cover and the illuminating direction of the LED lamp is toward the reflecting face, making the light irradiated from the LED light source able to be reflected outwardly by the reflecting face, when rotating the lamp cover, the relative position between the LED light source and the reflecting face being also changed, thus a variation of illuminating ranges being formed.

2. The LED fixture capable of performing light-beam adjustment according to claim 1, wherein the illuminating module further includes a cooler connected to the LED lamp and a circuit device providing a power source needed by the LED lamp.

3. The LED fixture capable of performing light-beam adjustment according to claim 1, wherein the reflecting face is a smooth face that has a specific curvature.

4. The LED fixture capable of performing light-beam adjustment according to claim 1, wherein the reflecting face is a rough face that has uneven stripes.

5. The LED fixture capable of performing light-beam adjustment according to claim 1, wherein the LED is arranged at the illuminating module with an angle ranging from 75 degrees to 105 degrees.

6. An LED fixture capable of performing light-beam adjustment, including
a lamp holder, one side of which is arranged an illuminating module having an LED lamp, the LED lamp being arranged at the illuminating module with an angle relative to a horizontally forward line; and
a lamp cover, which is movably combined to the lamp holder in a way, such that the combined lamp holder can rotate with respect to the lamp cover, making the LED lamp of the illuminating module rotated in the lamp cover;
wherein a reflecting face with a specific curvature is arranged on an inner face of the lamp cover, making the light irradiated from the LED light source able to be reflected outwardly by the reflecting face, when rotating the LED lamp, the relative position between the LED light source and the reflecting face being changed, thus a variation of illuminating ranges being formed.

7. The LED fixture capable of performing light-beam adjustment according to claim 6, wherein the illuminating module further includes a cooler connected to the LED lamp and a circuit device providing a power source needed by the LED lamp.

8. The LED fixture capable of performing light-beam adjustment according to claim 6, wherein the reflecting face is a smooth face that has a specific curvature.

9. The LED fixture capable of performing light-beam adjustment according to claim 6, wherein the reflecting face is a rough face that has uneven stripes.

10. The LED fixture capable of performing light-beam adjustment according to claim 6, wherein the LED is arranged at the illuminating module with an angle ranging from 75 degrees to 105 degrees.
